(19) United States
(12) Patent Application Publication
(10) Pub. No.: US 2007/0045094 A1
(43) Pub. Date: Mar. 1, 2007

(54) Unidirectional transmission

(75) Inventor: Bing Ding, Shen Zhen (CN)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Asia Optical Co., Inc.

(21) Appl. No.: 11/326,525

(22) Filed: Jan. 4, 2006

(30) Foreign Application Priority Data
Aug. 31, 2005 (TW) 094129957

(51) Int. Cl. H01H 5/00

(52) U.S. Cl. 200/400

(57) ABSTRACT

A unidirectional transmission includes a driver generating a torque selectively in a first direction and a second direction. A first passive member meshes with the driver and receives the torque from the driver. A second passive member meshes with the first passive member and receives the torque from the driver via the first passive member. A first unidirectional member engages with the first passive member to transmit the torque in the first direction, when the driver generates the torque in the second direction. A second unidirectional member engages with the second passive member to transmit the torque in the first direction, when the driver generates the torque in the first direction. An output member couples to the first unidirectional member and the second unidirectional member and selectively receives the torque in the first direction from the first and second unidirectional members.

### BACKGROUND OF THE INVENTION

1. Field of the Invention

The present invention relates to a unidirectional transmission, and more particularly, to a unidirectional transmission used in an office appliance or office machine.

2. Description of the Related Arts

Office equipment, such as printer, duplicator, and scanner, often comprises certain motor-based driving mechanisms to drive a tractor and/or image sensors. The tractor and the image sensor of the office appliance are required to move in a fixed direction, which means the driving mechanism must generate unidirectional rotation. Thus, a transmission is desired to ensure a unidirectional output of the driving mechanism, regardless forward or reversed rotation of a driving motor.

Referring to FIGS. 3 and 4 of the attached drawings, a conventional unidirectional transmission comprises a driver roller 91, which can be a toothed roller, a first gear 93 mating or otherwise drivingly coupled to the driver 91, an arm 92 connecting between centers of the driver roller 91 and the first gear 93, an output roller 97, second and third gears 94, 95 arranged between the first gear 93 and the output roller 97 for transmitting rotation from the driver roller 91 to the output roller 97, and a fourth gear 96 mating the output roller 97. The fourth gear 96 is selectively coupled to the driver roller 91 by swinging the arm 92 to move the first gear 93 away from the second gear 94 and into engagement with the fourth gear 96. In this respect, the arm 92 is rotatable at least within a given range of angular displacement with a rotation axis centered at the center of the driver roller 91.

In counterclockwise rotation, the driver roller 91 rotates counterclockwise, and induces a clockwise torque in the first gear 93, causing the first gear 93 to rotate clockwise. The arm 92 swings to right, making the first gear 93 mates with the second gear 94 due to a horizontal force from the driver 91, as illustrated in FIG. 3. The third gear 95 receives the torque via the second gear 94, and in turn transmits the torque to the output member 97. The output member 94 thus rotates counterclockwise. Referring to FIG. 4, in clockwise rotation, when the driver 91 rotates clockwise, a horizontal force is induced to swing the arm 92 leftward, making the first gear 93 mating the fourth gear 96, and transmitting a counterclockwise torque to the output member 97 via the fourth gear 96. Thus, the output member 97 rotates counterclockwise.

This conventional unidirectional transmission utilizes the horizontal force generated by the driver 91, with the arm 92 and the first gear 93 centering at the driver 91, to switch between different paths for transmission of the torque thereby enabling a unidirectional output.

China Patent Publication No. 151,757,6 describes another conventional unidirectional transmission. The unidirectional transmission comprises a driver, and an output member. The driver engages the output member via an auxiliary member and a passive member. The auxiliary member gears with the passive member. Both the auxiliary member and the passive member are fixed to a frame. The frame has a pair of shafts serving as rotation axes of the auxiliary member and the passive member, and a pivot between the axes to pivot therearound.

In operation, when the driver operates forwardly, the auxiliary member rotates reversely. Due to a horizontal force from the driver, the frame rotates about the pivot in a counterclockwise direction. The auxiliary member then gears with the output member, and the passive member deviates from the output member. Because there are two externally mated gears in the transmission path, the output member rotates in the same direction as the driver, and the output member operates forwardly.

When the driver operates reversely, the auxiliary member rotates forwardly, and the frame rotates clockwise about the pivot. The auxiliary member deviates from the output member, and the passive member gears with the output member. Thus, The rotation is transmitted through three externally mated gears to the output member, and consequently the direction that the output member rotates is opposite to the driver, and the output member operates forwardly.

The two conventional unidirectional transmissions respectively employ the arm 92 and the frame to alter the transmission path. However, the gears may be easy to bump each other when the arm 92 and the frame alter the transmission, which causes great noises and impairs the durability. Thus, such a design can only used in low speed systems.

Hence, an improved unidirectional transmission is required to overcome the disadvantages of the prior art.

### SUMMARY OF THE INVENTION

An object of the present invention is to provide a unidirectional transmission, which eliminates potential bumping between gears and thus removes disadvantages caused by gear bumping.

Another object of the present invention is to provide a unidirectional transmission, which can be used in a high-speed system.

A unidirectional transmission in accordance with the present invention comprises a driver generating a torque selectively in first and second directions. A first passive member meshes with the driver and receives the torque from the driver. A second passive member meshes with the first passive member and receives the torque from the driver via the first passive member. A first unidirectional member engages with the first passive member to transmit the torque in the first direction, when the driver generates the torque in the second direction. A second unidirectional member engages with the second passive member to transmit the torque in the first direction, when the driver generates the torque in the first direction. An output member couples to the first unidirectional member and the second unidirectional member and selectively receives the torque in the first direction from the first and second unidirectional members.

The present invention employs the first unidirectional spring and the second unidirectional spring to engage with the first passive member and the second passive members, thereby transmitting a unidirectional torque to the output member. Such a design avoids bumping between gears, decreases noise, and ensures an enduring life. In addition, such a design can be used in a high-speed system.

Other objects, advantages, and novel features of the invention will become more apparent from the following detailed description of a preferred embodiment when taken in conjunction with the accompanying drawings, wherein:

### BRIEF DESCRIPTION OF THE DRAWINGS

FIG. 1 is a schematic view of a unidirectional transmission in accordance with the present invention;

FIG. 2 is a schematic view of the unidirectional transmission showing the operation thereof;

FIG. 3 is a schematic view of a conventional unidirectional transmission showing the driver operates in clockwise direction; and

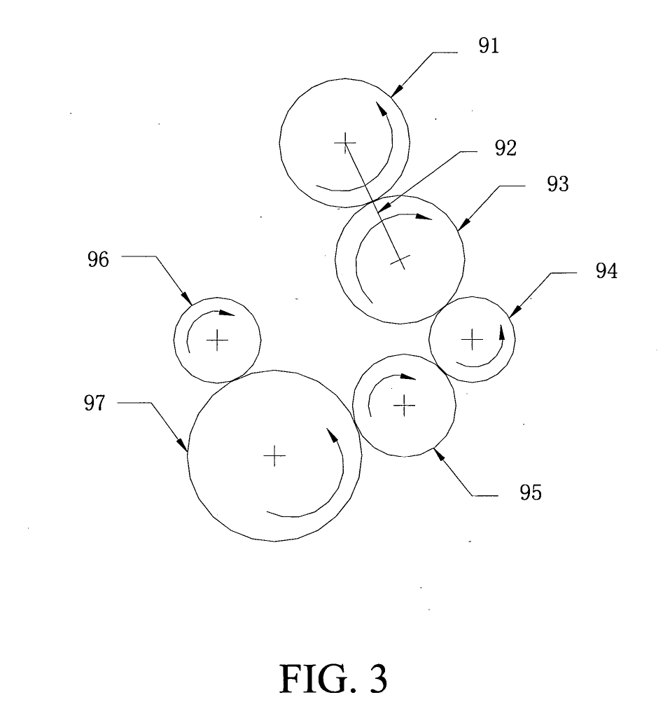

FIG. 4 is a schematic view of a conventional unidirectional transmission showing the driver operates in counterclockwise direction.

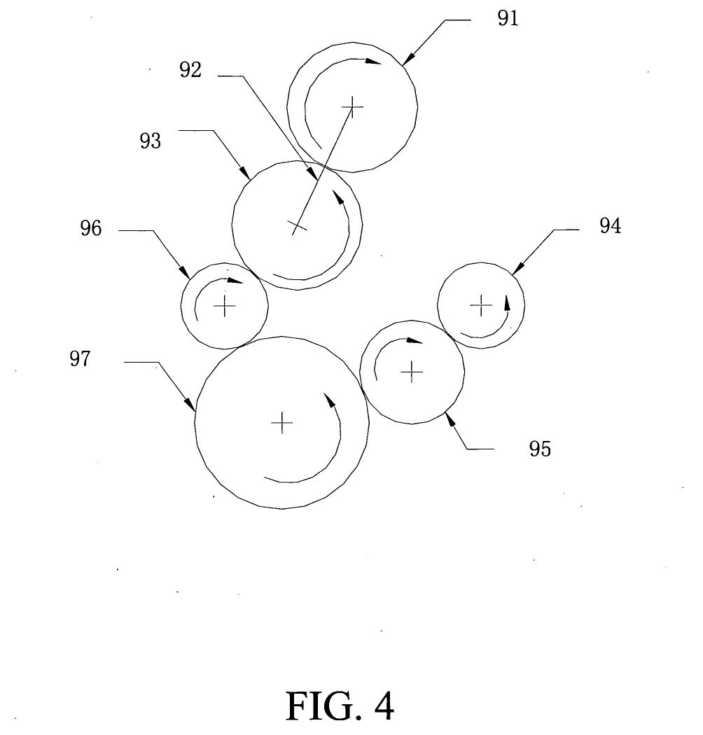

### DETAILED DESCRIPTION OF THE PREFFERRED EMBODIMENT

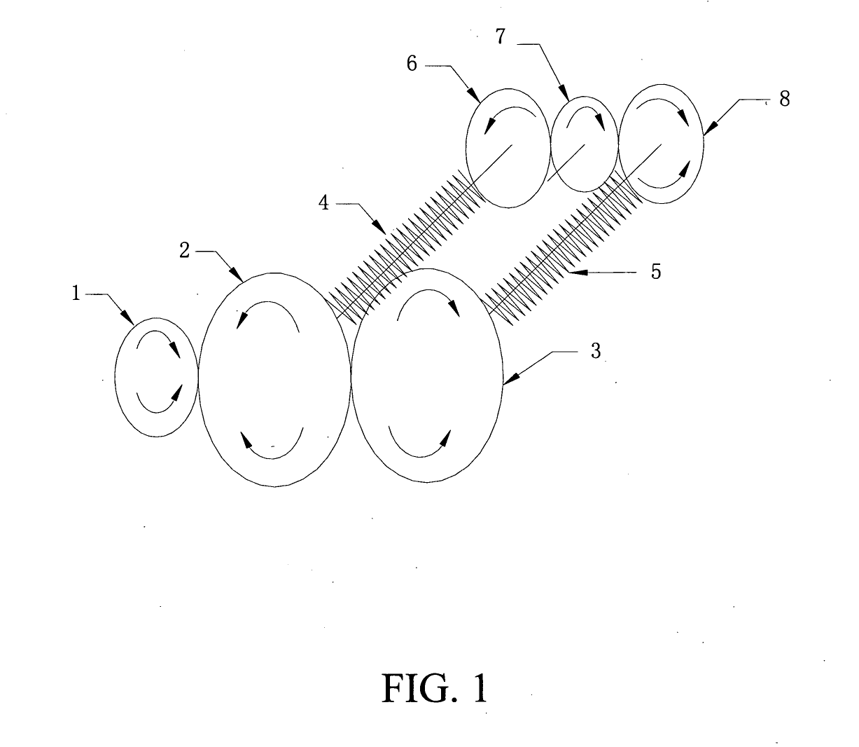

With reference to the drawings and in particular to FIG. 1, a unidirectional transmission in accordance with the present invention comprises a driver 1, an output member 8, a first passive member 2, and a second passive member 3. The first passive member 2 meshes with the driver 1, and the second passive member 3 meshes with the first passive member 2. A first unidirectional spring 4 and a second unidirectional spring 5 respectively engage with the first passive member 2 and the second passive member 3 to transmit a unidirectional torque. The second unidirectional spring 5 axially engages with the output member 8. The first unidirectional spring 4 engages with an auxiliary member 6, and transmits torque to the output member 8 via an idler 7 to effect a unidirectional output.

The driver 1 is driven by a motor (not shown) to selectively generate a clockwise torque or a counterclockwise torque, which is transmitted to the first passive member 2 and is further transmitted to the second passive member 3 via the first passive member 2 for the first passive member 2 and the second passive member 3 externally gear each other.

The first unidirectional spring 4 and the second unidirectional spring 5 are unidirectional devices, which allow torque or rotation to be transmitted in a preset direction, but not in a revised direction. The first unidirectional spring 4 engages with the first passive member 2. When the first passive member 2 rotates in a given direction, for example counterclockwise, the first unidirectional spring 4 locks with the first passive member 2, and transmits the torque to the auxiliary member 6 that is axially locked therewith in the given direction (namely counterclockwise in this example). When the first passive member 2 rotates in the reversed direction, namely clockwise in this example, the first unidirectional spring 4 breaks away from the first passive member 2, and the auxiliary member 6 is not moved. The second unidirectional spring 5 engages with the second passive member 3. When the second passive member 3 rotates counterclockwise, for example, the second unidirectional spring 5 locks with the second passive member 3, and transmits the torque to the output member 8 that axially locks with the second unidirectional spring 5 in the counterclockwise direction. When the second passive member 3 rotates clockwise, the second unidirectional spring 5 breaks away from the second passive member 3, and the output member 8 receives no torque from the second unidirectional spring 5.

The auxiliary member 6 axially engages with the first unidirectional spring 4. When the first unidirectional 4 locks with the first passive member 2, the first unidirectional spring 4 transmits the torque from the first passive member 2 to the auxiliary member 6, and the auxiliary member 6 rotates in the same direction as the first passive member 2.

The idler 7 mates between the auxiliary member 6 and the output member 8, and transmits torque from the auxiliary member 6 to the output member 8, making the rotation of the output member 8 in the same direction as the auxiliary member 6.

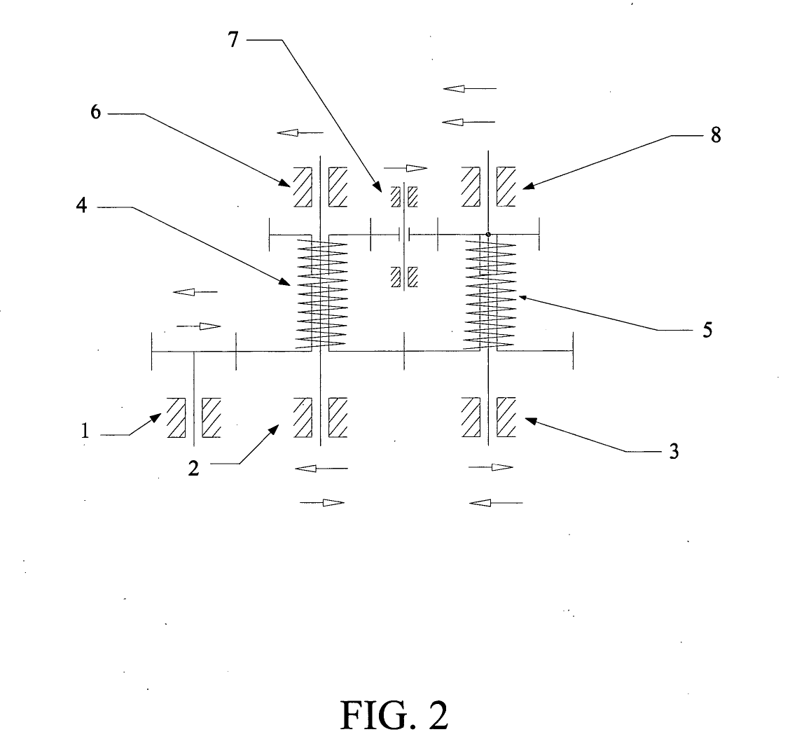

Referring to FIG. 2, in operation, when the driver 1 rotates clockwise, the first passive member 2 receives the torque from the driver 1, and rotates counterclockwise. The second passive member 3 rotates clockwise, due to direct engagement with the first passive member 2. In this situation, the first unidirectional spring 4 locks with the first passive member 2, and the second unidirectional spring 5 breaks away from the second passive member 3. The auxiliary member 6 receives the torque via the first unidirectional spring 4, rotates in the same direction as the first passive member 2, and transmits the torque to the output member 8 via the idler 7. The output member 8 then rotates counterclockwise.

When the driver 1 rotates counterclockwise, the first passive member 2 rotates clockwise, and the second passive member 3 rotates in the same direction as the driver 1. In this situation, the first unidirectional spring 4 breaks away from the first passive member 2, while the second unidirectional spring 5 locks the passive member 5. The second passive member 3 thus transmits the torque to the output member 8 via the second unidirectional spring 5, and the output member 8 rotates counterclockwise.

The present invention employs the first unidirectional spring 4 and the second unidirectional spring 5 engaging the first and second passive members 2 and 3, respectively, to transmit a unidirectional torque to the output member 8. Such a design avoids bumping between gears, decreases noise, and ensures an enduring life. Also, such a design can be used in high-speed systems.

It will be understood that the present invention may be embodied in other specific forms without departing from the spirit or central characteristics thereof. The present examples and embodiments, therefore, are to be considered in all respects illustrative and not restrictive, and the invention is not be limited to the details given herein.

What is claimed is:

1. A unidirectional transmission, comprising:
a driver generating a torque selectively in a first direction and a second direction;
a first passive member meshing with the driver and receiving the torque from the driver;
a second passive member meshing with the first passive member and receiving the torque from the driver via the first passive member;
a first unidirectional member engaging with the first passive member to transmit the torque in the first direction when the driver generates the torque in the second direction;
a second unidirectional member engaging with the second passive member to transmit the torque in the first direction when the driver generates the torque in the first direction; and
an output member coupled to the first unidirectional member and the second unidirectional member and selectively receiving the torque in the first direction from the first and second unidirectional members.

2. The unidirectional transmission as claimed in claim 1 further comprising an auxiliary member axially engaging with the first unidirectional member and coupled to the output member via an idler.

3. The unidirectional transmission as claimed in claim 1, wherein the second unidirectional member axially engages with output member.

4. The unidirectional transmission as claimed in claim 1, wherein when the first passive member rotates in the first direction, the first unidirectional member locks with the first passive member to transmit the torque in the first direction.

5. The unidirectional transmission as claimed in claim 4, wherein when the first passive member rotates in the second direction, the first unidirectional member breaks away from the first passive member.

6. The unidirectional transmission as claimed in claim 1, wherein when the second passive member rotates in the first direction, the second unidirectional member locks with the second passive member to transmit the torque in the first direction.

7. The unidirectional transmission as claimed in claim 6, wherein when the second passive member rotates in the second direction, the second unidirectional member breaks away from the second passive member.

8. The unidirectional transmission as claimed in claim 1, wherein the first unidirectional member and the second unidirectional member comprise unidirectional springs.

9. The unidirectional transmission as claimed in claim 1, wherein the first direction is counterclockwise, and the second direction is clockwise.

10. A unidirectional transmission, comprising:
a driver generating torque selectively in a first direction and in a second direction;
a first passive member meshing with the driver and receiving the torque from the driver;
a second passive member meshing with the first passive member and receiving the torque from the driver via the first passive member;
a first unidirectional member and a second unidirectional member respectively meshing with the first passive member and the second passive member; and
an output member engaging with the first unidirectional member and the second, unidirectional member, and selectively receiving the torque in the first direction from the first and second unidirectional members;
wherein when the driver generates the torque in a first direction, the second passive member is drivingly coupled to the second unidirectional member to transmit the torque in the first direction to the output member; and
wherein when the driver generates the torque in a second direction, the first passive member is drivingly coupled to the first unidirectional member to transmit the torque in a first direction to the output member.

11. The unidirectional transmission as claimed in claim 10 further comprising an auxiliary member axially engaging with the first unidirectional member, and coupled to the output member via an idler.

12. The unidirectional transmission as claimed in claim 10, wherein the second unidirectional member axially engages with output member.

13. The unidirectional transmission as claimed in claim 10, wherein when the driver generates torque in the first direction, the first passive member rotates in the second direction, and the first unidirectional member breaks away from the first passive member.

14. The unidirectional transmission as claimed in claim 10, wherein when the driver generates torque in the second direction, the second passive member rotates in the second direction, and the second unidirectional member breaks away from the second passive member.

15. The unidirectional transmission as claimed in claim 10, wherein the first unidirectional member and the second unidirectional member comprise unidirectional springs.

16. The unidirectional transmission as claimed in claim 10, wherein the first direction is counterclockwise, and the second direction is clockwise.
